(19) United States
(12) Patent Application Publication
(10) Pub. No.: US 2026/0365153 A1
(43) Pub. Date: Nov. 19, 2026

(54) RETAINER VALVE POSITION DETECTION

(71) Applicant: KB Intellectual Property GmbH & Co. KG, Pullach im Isartal (DE)

(72) Inventors: Derick Call, Evans Mills, NY (US); Mitchell Sanchez, Pittsford, NY (US); Jordan Doldo, Watertown, NY (US)

(73) Assignee: KB Intellectual Property GmbH & Co. KG, Pullach im Isartal (DE)

(21) Appl. No.: 19/672,817

(22) Filed: May 11, 2026

Related U.S. Application Data
(60) Provisional application No. 63/806,786, filed on May 16, 2025.

(51) Int. Cl. B60T 17/22

(52) U.S. Cl. CPC B60T 17/228

(57) ABSTRACT

An apparatus for determining the position of a retainer valve for a brake cylinder. The apparatus has a transducer for outputting a signal representing an amount of brake cylinder pressure in the rail car braking system a controller coupled to the transducer for receiving the signal. The controller tracks the change in brake cylinder pressure when the brakes are released. The controller then determines the position of the retainer valve based on the rate of change in the amount of brake cylinder pressure of the brake cylinder after the brakes are released and whether the brake cylinder pressure reached.

### CROSS-REFERENCE TO RELATED APPLICATIONS

The present application claims priority to U.S. Provisional Application No. 63/806,786, filed on May 16, 2025, hereby incorporated by reference in its entirety.

### BACKGROUND OF THE INVENTION

### 1. Field of the Invention

The present disclosure relates to railcar braking systems and, more particularly, to an approach for determining the position of a brake cylinder pressure retainer valve.

### 2. Description of the Related Art

When trying to monitor the health of control valve that complies with industry standards, such as those of the Association of American Railroads (AAR), there are several potential failure modes of the control valve that must be evaluated. For example, one failure mode involves the failure to release the brakes when commanded to do so, i.e., the control valve does not cause the brake cylinder pressure to exhaust and thus release the brakes. This failure may be a result of a failure of the control valve or the normal operation of a three-position retainer valve that is coupled downstream of the exhaust port that is used to vent brake cylinder pressure to atmosphere to selectively retain pressure in the brake cylinder.

A standard retainer valve has three operating positions. First, the retainer valve has a high pressure (HP) retain position, where the retainer valve only allows a partial release of brake cylinder pressure to a level that maintains the brakes in the applied position, such as approximately 20 pounds per square inch (PSI). Second, the retainer valve has a direct release (EX) position that allows a rapid and complete exhaust of brake cylinder pressure to 0 PSI. Finally, the retainer valve has a slow direct (SD) release position that allows for a slower, but complete, exhaust of brake cylinder pressure to 0 PSI.

In the event that there is any residual brake cylinder pressure remaining after the control valve has been commanded to release the brakes, it is currently not possible to determine whether the brake cylinder pressure is due to normal operation of the retainer valve or a failure of the control valve. Accordingly, there is a need in the art for an approach that can determine whether any residual brake cylinder pressure is the result of a fault of the control valve or proper operation of the retainer valve.

### BRIEF SUMMARY OF THE INVENTION

The present invention is an approach for determining the position of the retainer valve to confirm whether any retained brake cylinder pressure is due to a fault in the control valve or as a result of the normal operation of a retainer valve. The present invention thus provides for monitoring of the rate of change of brake cylinder pressure and the final brake cylinder pressure in response to a command to release the brakes. If the retainer valve is set to the high pressure (HP) retain position, the rate of change of brake cylinder pressure will be lower than the rate of change if the retainer valve is in either the direct release (EX) release position or the slow direct (SD) release position. If the retainer valve is in either the direct release (EX) release position or the slow direct (SD) release position, a properly functioning control valve will release brake cylinder pressure down to 0 PSI.

In one embodiment, the present invention may be an apparatus for determining a position of a retainer valve for a brake cylinder that includes a transducer for outputting a signal representing an amount of brake cylinder pressure in a rail car braking system and a controller coupled to the transducer for receiving the signal. The controller is programmed to track a change in the amount of brake cylinder pressure over time in response to a release of brake cylinder pressure from a first pressure to a second pressure that is less than the first pressure and to determine a position of the retainer valve based on a rate of change in the amount of brake cylinder pressure from the first pressure to the second pressure and based on whether the second pressure is a zero pressure or a non-zero pressure. The transducer and the controller may be incorporated into a control valve. The transducer and the controller may be incorporated into a housing. The transducer may be interconnected to a source of brake cylinder pressure that provides the amount of brake cylinder pressure. The transducer may be connected to the source of brake cylinder pressure between a control valve and a retainer valve. The position of the retainer valve may be determined to be in a direct release (EX) release position if the amount of brake cylinder pressure transitions to zero in less than sixty seconds. The position of the retainer valve may be determined to be in slow direct (SD) release position if the amount of brake cylinder pressure transitions to zero in about 330 seconds. The position of the retainer valve may be determined to be in a high pressure (HP) retain position if the amount of brake cylinder pressure transitions to the non-zero pressure in about 240 seconds.

In another embodiment, the present invention may be a method of determining the position of a retainer valve for a brake cylinder. The method may include tracking the amount of brake cylinder pressure over time when the amount of brake cylinder pressure decreases from a first pressure to a second pressure, wherein the second pressure is one of a zero pressure and a non-zero pressure. The method may also include determining a rate of change in the amount of brake cylinder pressure from the first pressure to the second pressure. The method may further include determining the position of the retainer valve based on the rate of change in the amount of brake cylinder pressure and whether the second pressure is the zero pressure or the non-zero pressure. The position of the retainer valve may be determined to be a direct release (EX) release position if the second pressure is the zero pressure and the rate of change is above twenty pounds per square inch (PSI) per minute. The position of the retainer valve may be determined to be in a slow direct (SD) release position if the second pressure is the zero pressure and the rate of change is about twenty pounds per square inch (PSI) per minute. The position of the retainer valve may be determined to be a high pressure (HP) retain position if the second pressure is a non-zero pressure and the rate of change was ten pounds per square inch (PSI) per minute or lower. The non-zero pressure may be about twenty (20) pounds per square inch (PSI).

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of an apparatus for determining the position of a retainer valve according to the present invention.

FIG. 2 is a graph of brake cylinder pressure over time depending on the position of the retainer valve according to the present invention.

FIG. 3 is a flowchart of an exemplary method for determining the position of a retainer valve according to the present invention.

### DETAILED DESCRIPTION OF THE INVENTION

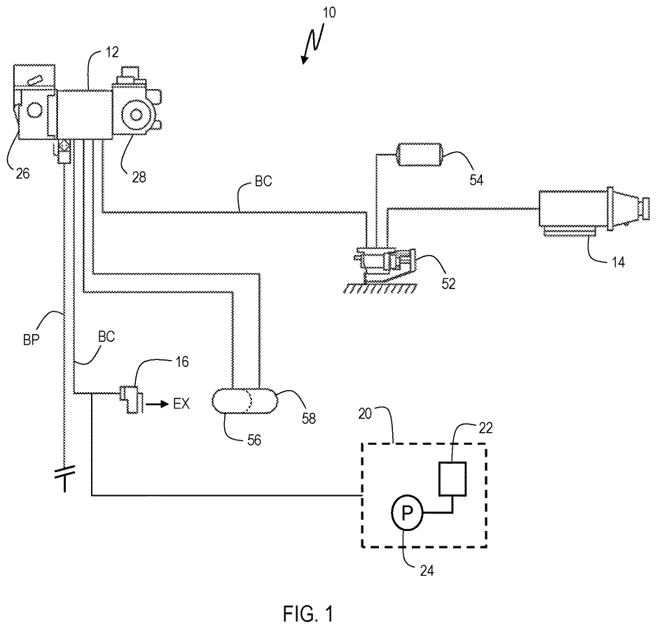

Referring to the figures, wherein like numerals refer to like parts throughout, there is seen in FIG. 1, a schematic a rail car braking system 10 including a control valve 12 that, among things, controls the amount of brake cylinder (BC) pressure provided to a brake cylinder 14 to selectively apply and release the brakes of a rail car, such in response to a pneumatic signal provided by a change in pressure of the train brake pipe (BP). As is known in the field, control valve 12 may include a service portion 26 and an emergency portion 28.

A retainer valve 16 may be coupled to BC pressure downstream of the port of control valve 12 that is used to exhaust brake cylinder pressure. Retainer valve 16 is conventionally used to control the release of brake pressure from brake cylinder 14 to atmosphere EX. As an example, retainer valve 16 may be used to maintain pressure in brake cylinder 14 despite a loss of pressure in the braking system, such as when a train is parked on a grade and the air supply system turned off, but the brakes need to be maintained in the brakes applied position to prevent movement of the train. Retainer valve 16 may thus have a high pressure (HP) retain position, where the retainer valve only allows a partial release of brake cylinder pressure to a level that maintains the brakes in the applied position, a direct release (EX) position that allows a rapid and complete exhaust of brake cylinder pressure to zero PSI, and a slow direct (SD) release position where brake cylinder pressure is more gradually reduced to zero.

As seen in FIG. 1, a monitor 20 may be coupled to brake pressure (BC) and used to determine the position of retainer valve 16. Monitor 20 comprises a controller 22 that is coupled to one or more pressure transducers 24 that can accurately measure the amount of brake cylinder pressure. Controller 22 is programmed to track the measured amount of brake cylinder pressure over time after a release of the brakes by control valve 12. Monitor 20 may be integrated into existing hardware, such as by incorporating monitor 20 and controller 22 into a new or existing module of control valve 12, or provided in a separate housing that is coupled to an appropriate location in braking system 10 where brake cylinder pressure can be measured. As further seen in FIG. 1, braking system 10 may include an empty/load device 52 and accompanying volume 54 between control valve 12 and brake cylinder 14. An emergency reservoir 56 and auxiliary reservoir 58 may also be coupled to control valve 12.

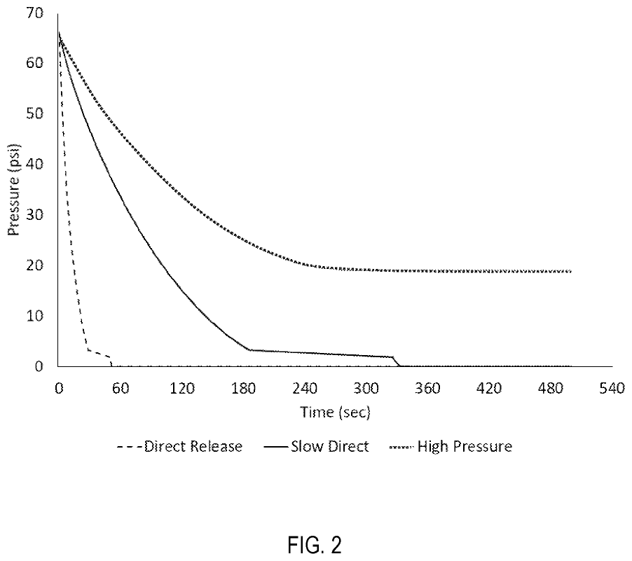

Controller 22 is programmed to track the brake cylinder pressure over time once control valve 12 has received a command to release the brakes and begins to release brake cylinder pressure to atmosphere. Referring to FIG. 2, the rate of change in brake pressure over time, as well as the final brake cylinder pressure, will differ depending on whether retainer valve 16 is in the direct release (EX) position, the high pressure (HP) retain position, or the slow direct (SD) exhaust position. For example, as seen in FIG. 2, if retainer valve 16 is in the direct release (EX) position, brake cylinder pressure will drop from a fully pressurized state, such as about sixty-five (65) PSI, to zero PSI in less than sixty (60) seconds. If retainer valve 16 is in the slow release (SD) position, however, brake cylinder pressure will drop from the fully pressurized state to zero in about 330 seconds. Finally, if retainer valve 16 is in the high pressure (HP) retain position, brake cylinder pressure will drop from the fully pressurized state to a partially pressurized state, such as about twenty (20) PSI, in about 240 seconds. Thus, the final pressure in combination with the rate of change of pressure between the time when the brake cylinder pressure is first released to when it stabilizes can reveal the particular state of the retainer valve.

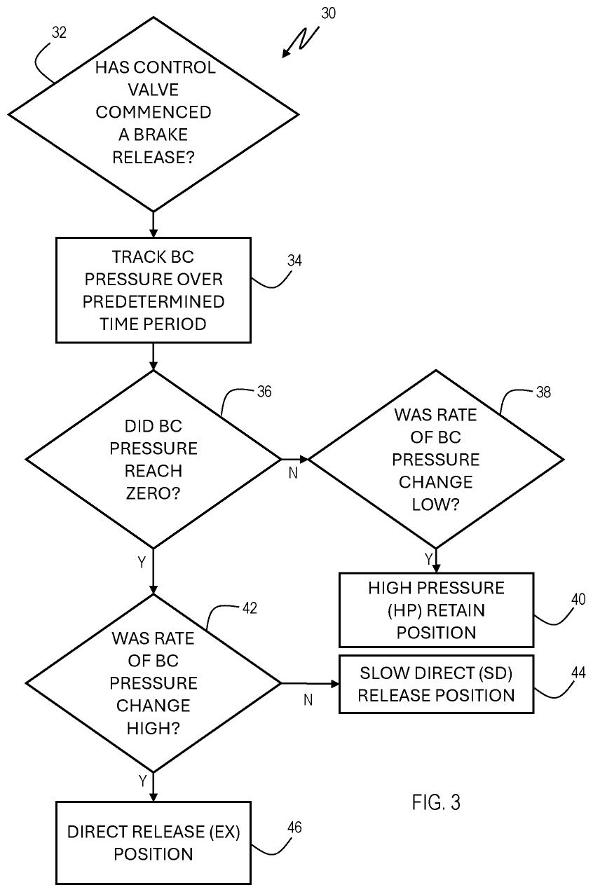

As seen in FIG. 3, controller 22 may be programmed to perform a retainer valve position detection process 30 to determine the state of retainer valve 16. After a determination that control valve 12 has commenced a release of the brakes at step 32, controller 22 detects and tracks the brake cylinder pressure over a predetermined time period at step 34, such as at least 330 seconds, or at least until the brake cylinder pressure stabilizes at a pressure level below the brakes applied pressure. Controller 22 is then programmed to evaluate the rate of change of pressure as well as the final brake cylinder pressure to detect the position of retainer valve 16. As one example, controller 22 may check whether the brake cylinder pressure reached zero at step 36. If not, controller 22 can check whether the rate of change of brake pressure was low (such as below a predetermined threshold based on the high pressure (HP) retain rate of change) at step 38 to decide that retainer valve 16 is in the high pressure (HP) retain position 40 because the rate of change of brake cylinder pressure was low (e.g., 10 PSI per minute or slower) and the brake cylinder pressure did not reach zero PSI. If the brake cylinder pressure reached zero, controller 22 may then check whether the rate of change was high (such as above a predetermined threshold based on the direct release (EX) rate of change) at step 42. If not, controller 22 can decide that retainer valve 16 is in the slow direct (SD) release position 44 because the rate of change of brake cylinder pressure was moderate (e.g, 20 PSI per minute) and reached 0 PSI. If step 42 determines that the rate of change was high, such as by exceeding the threshold, controller 22 can decide that retainer valve 16 is in the direct release (EX) position 46 because the rate of change of brake cylinder pressure was high (e.g., 65 PSI per minute) and reached zero PSI.

What is claimed is:

1. An apparatus for determining a position of a retainer valve for a brake cylinder, comprising:
a transducer for outputting a signal representing an amount of brake cylinder pressure in a rail car braking system; and
a controller coupled to the transducer for receiving the signal, wherein the controller is programmed to track a change in the amount of brake cylinder pressure over time in response to a release of brake cylinder pressure from a first pressure to a second pressure that is less than the first pressure; and
wherein the controller is further programmed to determine a position of the retainer valve based on a rate of change in the amount of brake cylinder pressure from the first pressure to the second pressure and based on whether the second pressure is a zero pressure or a non-zero pressure.

2. The apparatus of claim 1, wherein the transducer and the controller are incorporated into a control valve.

3. The apparatus of claim 1, wherein the transducer and the controller are incorporated into a housing.

4. The apparatus of claim 3, wherein the transducer is interconnected to a source of brake cylinder pressure that provides the amount of brake cylinder pressure.

5. The apparatus of claim 4, wherein the transducer is connected to the source of brake cylinder pressure between a control valve and a retainer valve.

6. The apparatus of claim 1, wherein the position of the retainer valve is determined to be in a direct release (EX) position if the amount of brake cylinder pressure transitions to zero in less than sixty seconds.

7. The apparatus of claim 1, wherein the position of the retainer valve is determined to be in a slow direct (SD) release position if the amount of brake cylinder pressure transitions to zero in about 330 seconds.

8. The apparatus of claim 1, wherein the position of the retainer valve is determined to be in a high pressure (HP) retain position if the amount of brake cylinder pressure transitions to the non-zero pressure in about 240 seconds.

9. A method of determining a position of a retainer valve for a brake cylinder, comprising:
tracking an amount of brake cylinder pressure over time when the amount of brake cylinder pressure decreases from a first pressure to a second pressure, wherein the second pressure is one of a zero pressure and a non-zero pressure;
determining a rate of change in the amount of brake cylinder pressure from the first pressure to the second pressure; and
determining the position of the retainer valve based on the rate of change in the amount of brake cylinder pressure and whether the second pressure is the zero pressure or the non-zero pressure.

10. The method of claim 9, wherein the position of the retainer valve is determined to be direct release (EX) position if the second pressure is the zero pressure and the rate of change is above twenty pounds per square inch (PSI) per minute.

11. The method of claim 10, wherein the position of the retainer valve is determined to be in a slow direct (SD) release position if the second pressure is the zero pressure and the rate of change is about twenty pounds per square inch (PSI) per minute.

12. The method of claim 11, wherein the position of the retainer valve is determined to be a high pressure (HP) retain position if the second pressure is a non-zero pressure and the rate of change was ten pounds per square inch (PSI) per minute or lower.

13. The method of claim 12, wherein the non-zero pressure is about twenty (20) pounds per square inch (PSI).
